(19) United States
(12) Patent Application Publication
(10) Pub. No.: US 2007/0294089 A1
(43) Pub. Date: Dec. 20, 2007

(54) Gameplay Recording and Marketplace

(76) Inventors: Zachary A. Garbow, Rochester, MN (US); Michael A. Nelson, Kansas City, MO (US); Kevin G. Paterson, San Antonio, TX (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/421,808

(22) Filed: Jun. 2, 2006

(51) Int. Cl. G06Q 10/00; G07G 1/14; G06Q 30/00

(52) U.S. Cl. 705/1; 705/14

(57) ABSTRACT

The present invention generally provides methods and systems for recording and distributing information on various aspects of videogame play (gameplay). In one embodiment, a method of providing gaming information may include receiving gaming information recorded during gameplay by a user during execution of a gaming application. The gaming information may be in an electronic format and may be stored on a computer readable storage medium. The method may also include making the gaming information available for sale.

### BACKGROUND OF THE INVENTION

1. Field of the Invention

The present invention generally provides methods and systems for recording and distributing information on various aspects of videogame play (gameplay).

2. Description of the Related Art

Videogames constitute a multi-billion dollar industry in which the games are becoming increasing complex. Videogames today have detailed characters, three-dimensional backgrounds, and intricate story lines. Additionally, videogame creators frequently include secret levels, bonus items, Easter eggs, and other hidden features in videogames.

Often, today's videogames are so complicated and/or difficult that videogame players (gamers) get stuck at a point in the game and need help determining how to proceed. To this end, millions of dollars are spent every year on solution/cheat books, magazine subscriptions, and even television programs to assist gamers on every aspect of videogames, including overcoming challenging game obstacles and locating hidden game material. While these resources may teach the gamer how to accomplish a given task, text and stationary photographs are not always capable of communicating the intricacies of gameplay. Furthermore, with the already large and always growing selection of videogames, the gaming information released in scheduled media, like television or magazines, is unlikely to be the gaming information the gamer is looking for at the time of release.

Accordingly, what is needed is an improved method and apparatus for gamers to obtain gaming information.

### SUMMARY OF THE INVENTION

The present invention generally provides methods and systems for recording and distributing information on various aspects of videogame play (gameplay). In one embodiment, a method of providing gaming information may include receiving gaming information recorded during gameplay by a user during execution of a gaming application. The gaming information may be in an electronic format and may be stored on a computer readable storage medium. The method may also include making the gaming information available for sale.

In one embodiment, a method for recording gaming information may include recording inputs of a user received by a gaming application during execution of a segment of gameplay. The method may also include recording outputs produced by the gaming application during execution of the segment of gameplay. Such outputs may include at least one of visual outputs, audio outputs, gameplay parameters and combinations thereof.

In one embodiment, a tangible computer-readable medium containing a program product may be provided. When executed by a processor, the program product may perform an operation that may include receiving gaming information recorded during gameplay by a user during execution of a gaming application. The gaming information may be in an electronic format and may be stored on a computer readable storage medium. The operation may also include making the gaming information available for sale.

In one embodiment, a tangible computer-readable medium containing a program product may be provided. When executed by a processor, the program product may perform an operation that may include recording inputs of a user received by a gaming application during execution of a segment of gameplay. The operation may also include recording outputs produced by the gaming application during execution of the segment of gameplay. Such outputs may include at least one of visual outputs, audio outputs, gameplay parameters and combinations thereof.

In one embodiment, a system including a processor and a memory is provided. The system may further include gaming information which may include inputs of a user received by a gaming application during execution of a segment of gameplay. The gaming information may also include outputs produced by the gaming application during execution of the segment of gameplay. Such outputs may include at least one of visual outputs, audio outputs, gameplay parameters and combinations thereof. The inputs and outputs may have been recorded during execution of the segment of gameplay in a manner that may allow for the gaming information to be transmitted electronically and that may allow the segment of gameplay to be subsequently reproduced on a gaming system different from the gaming system on which the gaming information was recorded.

In one embodiment, a system including a processor and a memory is provided. The system may further include a web application which may be configured to display representations of a plurality of gaming information files, each containing gaming information recorded during a gaming session defined by execution of a segment of gameplay. The web application may be further configured to receive requests to purchase selected ones of the gaming information files. The requests may include a form of electronic payment. The web application may be further configured to transmit the selected ones of the gaming information files to respective purchasers.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for distributing gaming information, according to one embodiment of the invention;

FIG. 2 is a block diagram illustrating a networked system in which embodiments of the present invention may be implemented, according to one embodiment of the invention;

FIG. 3A is a block diagram illustrating a data structure for storing the gaming information and a descriptive tag, according to one embodiment of the invention;

FIG. 3B is a block diagram illustrating a data structure for storing gaming information and a separate data structure for storing a descriptive tag related to the gaming information, according to one embodiment of the invention;

FIG. 4 is a flow diagram depicting a process for the creation of the data structure for storing gaming information and at least one descriptive tag, according to one embodiment of the invention;

FIG. 5 is a flow diagram depicting a process for requesting, creating, and obtaining gaming information, according to one embodiment of the invention;

FIG. 6 is a block diagram illustrating a graphical user interface (GUI) displaying an in-game prompt a first videogame player (gamer) receives when requesting gaming information for a section of a videogame, according to one embodiment of the invention;

FIG. 7 is a block diagram illustrating a GUI containing references to a plurality of gaming information, according to one embodiment of the invention;

FIG. 8 is a block diagram illustrating a GUI containing information pertaining to specific gaming information, according to one embodiment of the invention;

FIG. 9 is a block diagram illustrating a GUI displaying playback of specific gaming information, according to one embodiment of the invention.

FIG. 10 is a block diagram illustrating a GUI displaying an in-game prompt a second gamer receives when playing the section of the videogame for which the first gamer has requested gaming information, according to one embodiment of the invention;

FIG. 11 is a block diagram illustrating an empty data structure for storing gaming information and at least one descriptive tag, according to one embodiment of the invention;

FIG. 12 is a block diagram illustrating a GUI displaying the section of the videogame being played by the second gamer while concurrently recording gaming information, according to one embodiment of the invention;

FIG. 13 is a block diagram illustrating the data structure for storing gaming information and at least one descriptive tag while the second gamer is recording gaming information, according to one embodiment of the invention;

FIG. 14 is a block diagram illustrating a GUI displaying the completion of the section of the videogame played by the second gamer for which the first gamer may have requested gaming information, according to one embodiment of the invention;

FIG. 15 is a block diagram illustrating the data structure for storing gaming information and at least one descriptive tag after the second gamer has completed recording gaming information, according to one embodiment of the invention;

FIG. 16 is a block diagram illustrating a GUI displaying an in-game prompt the second gamer receives after completing the section of the videogame for which the first gamer may have requested the gaming information, according to one embodiment of the invention;

FIG. 17 is a block diagram illustrating the data structure for storing gaming information and at least one descriptive tag after the one or more descriptive tags have been entered, according to one embodiment of the invention;

FIG. 18 is a block diagram illustrating a GUI containing updated references to the plurality of gaming information including the gaming information newly created by the second gamer, according to one embodiment of the invention;

FIG. 19 is a flow diagram depicting a process for creating, and obtaining gaming information, according to one embodiment of the invention;

FIG. 20 is a flow diagram depicting a process for creating and storing gaming information, according to one embodiment of the invention; and

FIG. 21 is a block diagram illustrating a GUI for prompting a gamer to upload outstanding gaming information, according to one embodiment of the invention.

### DETAILED DESCRIPTION OF THE PREFERRED EMBODIMENTS

The present invention generally provides methods and systems for recording and distributing information on various aspects of videogame play (gameplay). In one embodiment, a method of providing gaming information may include receiving gaming information recorded during gameplay by a user during execution of a gaming application. The gaming information may be in an electronic format and may be stored on a computer readable storage medium. The method may also include making the gaming information available for sale.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### System for Distributing Gaming Information

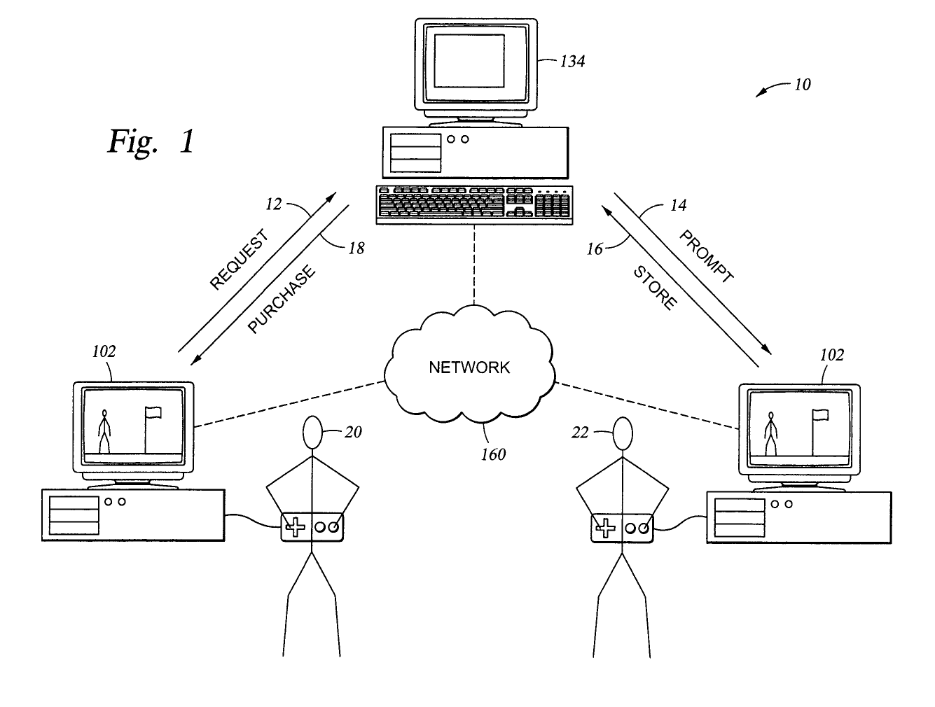

FIG. 1 is a block diagram illustrating a system for distributing gaming information 10, according to one embodiment of the invention. The system includes a first videogame player (gamer) 20 of a first gaming system 102, a second gamer 22 of a second gaming system 102, and a network 160 connecting the first and second gaming systems 102. In one embodiment, the network 160 may include a gaming information exchange server 134. Gaming information may include a depiction of the gameplay of a gamer as will be explained in more detail below.

In one embodiment, the system for distributing gaming information 10 may be used to create, distribute, and review gaming information pertaining to videogame play (gameplay). For example, the first gamer 20 may reach a section of a videogame that the first gamer 20 may be unable to complete. The first gamer 20 may request 12 gaming information depicting how to complete the section of the videogame. The request 12 may be sent via the network 160 to the gaming information server 134.

In one embodiment, the request 12 of the first gamer 20 may be sent from the gaming information exchange server 134 to the gaming system 102 of the second gamer 22 via the network 160. The request 1 2 of the first gamer 20 may trigger a prompt 14 on the gaming system 102 of the second gamer 22 to record the gameplay of the second gamer 22 while playing the section of the videogame that the first gamer 20 was unable to complete. The prompt 14 on the gaming system 102 of the second gamer 22 may occur during gameplay when the second gamer 22 reaches the section of the videogame that the first gamer 20 was unable to complete. Alternatively, the prompt 14 on the gaming system 102 of the second gamer 22 may occur at any time and/or may be stored in a table of pending requests accessible by the second gamer 22.

In one embodiment, the second gamer 22 may record gameplay as gaming information while playing the section of the videogame that the first user 20 was unable to complete. The second gamer 22 may store 16 this gaming information on the gaming information exchange server 134 via the network 160.

In one embodiment, the first gamer 20 may locate and purchase 18 the gaming information of the second gamer 22 stored on the gaming information exchange server 134 via the network 160. The first gamer 20 may then review the gaming information of the second gamer 22 to learn how to complete the section of the videogame that the first gamer 20 was initially unable to complete.

### Networked System

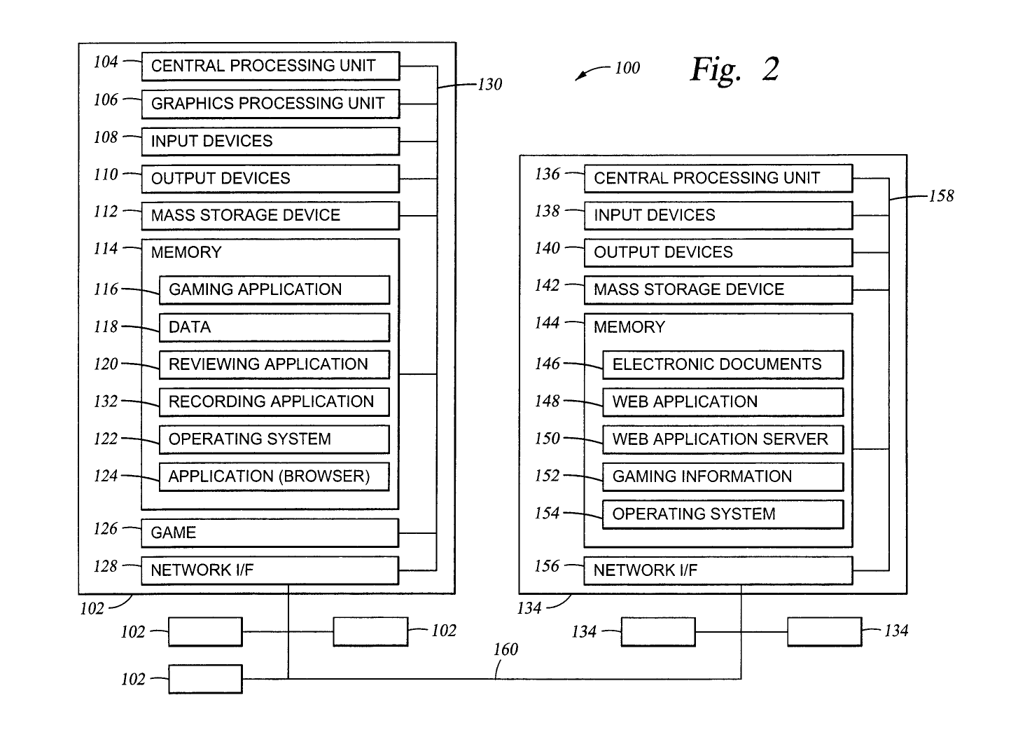

One embodiment of the invention is implemented as a program product for use with a computer system such as, for example, a gaming system 102 shown in FIG. 2 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 2 depicts a block diagram of a networked system 100 in which embodiments of the present invention may be implemented. In general, the networked system 1 00 includes a gaming system 102 (four such gaming system 102 are shown) and at least one gaming information exchange server 134 (three such gaming information exchange servers 134 are shown). The gaming system 102 and the gaming information exchange server 134 are connected via a network 160. In general, the network 160 may be a local area network (LAN) and/or a wide area network (WAN). In a particular embodiment, the network 160 is the Internet.

The gaming system 102 includes a Central Processing Unit (CPU) 104 connected via a bus 130 to a memory 114, storage device 112, a graphics processing unit 106, a game 126, an input device 108, an output device 11 0, and a network interface device 128. The input device 108 can be any device to give input to the gaming system 102. For example, a keyboard, keypad, light pen, touch-screen, track-ball, speech recognition unit, audio/video player, or videogame controller could be used. Examples of the videogame controller include a joystick, a control pad, an infrared controller, and an electronic steering wheel and throttle control. The output device 110 can be any device to give output to the user, e.g., any conventional display screen or set of speakers along with their respective interface cards, i.e., video card and sound card. Although shown separately from the input device 108, the output device 110 and input device 108 could be combined. For example, a display screen with an integrated touch-screen, a display with an integrated keyboard, a speech recognition unit combined with a text speech converter, or a videogame controller that provides force feedback and/or visual feedback to its user could be used.

The game 126 may be a videogame configured to run on the gaming device 102. The game 126 may be locally run, e.g., from a gaming cartridge, from a CD-ROM disk, and/or from a file on the storage device 112. Alternatively, the game may be run over a network, or may be run from a combination of local and network resources.

The network interface device 128 may be any entry/exit device configured to allow network communications between the gaming system 102 and the gaming information exchange server 134 via the network 160. For example, the network interface device 1 28 may be a network adapter or other network interface card (NIC).

Storage 112 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 114 and storage 112 could be part of one virtual address space spanning multiple primary and secondary storage devices.

The gaming system 102 is generally under the control of an operating system 122, which is shown in the memory 11 4. Illustrative operating systems, which may be used to advantage, include Linux® (Linux is a trademark of Linus Torvalds in the US, other countries, or both) and Microsoft Windows. More generally, any operating system supporting the functions (e.g., gaming, browsing, etc.) disclosed herein may be used.

Information located in the memory 114 may also include a browser application 124, a gaming application 116, one or more data 118 files that may contain gaming information, a reviewing application 120, and/or a recording application 132. The browser application 124 may be used by the gamer to search the gaming information exchange server 134 for gaming information, as will be described below. The gaming application 116 may execute a videogame 126 on the gaming system 102. The recording application 132 may be used to record inputs and outputs of the gaming application 116 on the gaming system 102, as will be described below. The reviewing application 120 may be used to review previously recorded inputs and outputs of the gaming application 116 as will be described below.

The memory 114 is preferably a random access memory sufficiently large to hold the necessary programming and data structures of the invention. While the memory 114 is shown as a single entity, it should be understood that the memory 114 may in fact comprise a plurality of modules, and that the memory 114 may exist at multiple levels, from high speed registers and caches to lower speed but larger DRAM chips.

Illustratively, the memory 114 includes an application 124 that, when executed on CPU 104, provides support for exchanging information between the various gaming information exchange servers 134 and locating network addresses at one or more of the gaming information exchange servers 134. In one embodiment, the application 124 is a web browser that includes a web-based Graphical User Interface (GUI), which allows the user to navigate and display web pages located on the Internet. However, more generally the application may be a thin client application configured to transfer data (e.g., HTML, XML, etc.) between the gaming system 102 and the gaming information exchange servers 134 via, for example, HTTP. By way of example only, the application 124 will be referred to herein as a browser.

Each gaming information exchange server computer 134 generally comprises a CPU 136, a memory 144, and a storage device 142, coupled to one another by a bus 158. Memory 144 may be a random access memory sufficiently large to hold the necessary programming and data structures that are located on the gaming information exchange server 134. The programming and data structures may be accessed and executed by the CPU 136 as needed during operation. As shown, the memory 144 includes a Web application server 150 and a Web application 148. The Web application server 150 is adapted to service requests from the gaming system 102 which invoke the Web application 148. In turn, the Web application 148 may perform various functions which include generating, accessing and/or populating electronic documents 146 (e.g., markup language documents such as HTML documents and XML documents) residing on the gaming information exchange server computer 134. As used herein, an “electronic document” is machine-readable data, regardless of the medium of storage or transmission. In one embodiment, the documents 146 are Web pages each having an associated network address. Although the documents are shown in FIG. 2 residing on the gaming information exchange server computer 134, it should be understood that the documents 146 need not be static, but instead may be generated by the Web application 148. By way of illustration, the Web application server 150 may be an instance of the Tomcat or IBM WebSphere products. Websphere is available from International Business Machines, Inc. Further, the Web application 148 may be configured to access a back end database or perform other functions. By way of illustration, the Web application 148 may be a stock quote retrieval application, an e-commerce application such as eBay, or an e-business application such as IBM Connect, or a Portal environment such as IBM Websphere portal server, which runs in an application environment. However, more generally, it is contemplated that the invention is adaptable to any application server and applications.

FIG. 2 is merely one hardware/software configuration for the networked gaming system 102 and gaming information exchange server 134. Embodiments of the present invention can apply to any comparable hardware configuration, regardless of whether the computer systems are complicated, multi-user computing apparatus, single-user workstations, or network appliances that do not have non-volatile storage of their own. In particular, it is noted that while the gaming system 102 is described as a general purpose computer, the gaming system may in fact include a gaming console primarily or exclusively configured for gaming. The gaming console may have a recording application 132 configured to perform the game information recording function described herein. It is further contemplated that the gaming console may have a communication interface allowing communication with another computer system on which the browser application 124, recording application 132, and other applications or functions reside. Further, it is understood that while reference is made to particular languages, including HTML, XML and JAVA, the invention is not limited to a particular language, standard or version. Accordingly, persons skilled in the art will recognize that the invention is adaptable to other languages and that the invention is also adaptable to future changes in a particular language as well as to other languages presently unknown. Further, the Web application server 150 and Web application 148 are merely illustrative and other embodiments adapted to support any known and unknown protocols/functions are contemplated.

### Data Structure

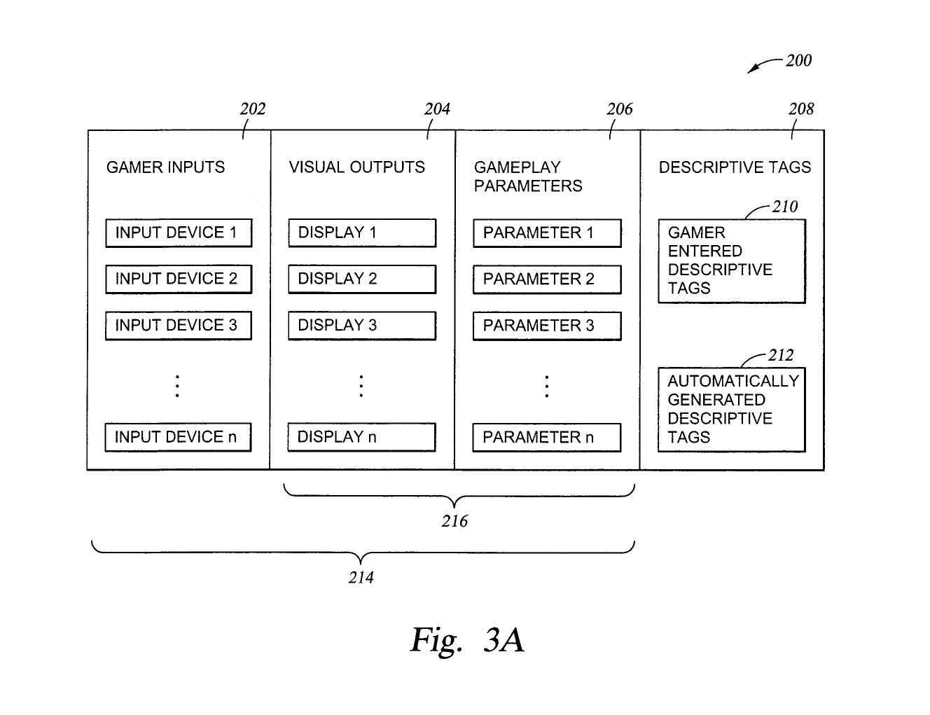

FIG. 3A is a block diagram illustrating a data structure 200 for storing gaming information 214 and one or more descriptive tags 208, according to one embodiment of the invention. In one embodiment, gaming information 214 is any electronically stored information recorded by the recording application 132 during gameplay on the gaming system 102. For example, the gaming information 214 may include inputs 202 by a gamer 22 into the gaming system 102 and outputs 216 of the gaming system 102. The descriptive tag 208 may include one or more gamer-entered descriptive tags 210 and one or more automatically generated descriptive tags 212 created by the gaming system 102.

In one embodiment, gamer inputs 202 into gaming system 102 are stored in the data structure 200. Gamer inputs 202 may constitute any action by the gamer 22 on the gaming system 102. For example, gamer inputs 202 may include typing on a keyboard connected to the gaming system 102, pressing buttons on a controller connected to the gaming system 102, talking or singing into a microphone connected to the gaming system 102, and/or moving a mouse connected to the gaming system 102.

In one embodiment, outputs 216 from the gaming system 102 are stored in the data structure 200. Outputs 216 may constitute any information from the gaming system 102 resulting from the gamer inputs 202 into the gaming system 102. For example, the outputs 216 may include visual output 204 from the gaming system 102, audio output from the gaming system 102, and/or gameplay parameters 206 from the gaming system 102. Gameplay parameters 206 are background information generated by the gaming system 102 that may be related to gameplay and may include such information as score on a section of gameplay, time to complete a section of gameplay, force feedback of a gaming controller, and/or level of difficulty of gameplay.

In one embodiment, one or more descriptive tags 208 are stored in the data structure 200. Descriptive tags 208 are tags that describe the basic aspects of recorded gameplay. Descriptive tags 208 may be gamer-entered descriptive tags 210 and/or automatically generated descriptive tags 212 created by the gaming system 102. Gamer-entered descriptive tags 210 may be entered by a gamer 22 upon creation of the gaming information 214 related to the descriptive tags 210. For example, gamer-entered descriptive tags 210 may include one or more comments about the gaming information 214, a name of the videogame 126 recorded during gameplay, and/or a section of the videogame 126 recorded during gameplay. Automatically generated descriptive tags 212 may be entered automatically by the gaming system 102 upon creation of the gaming information 214, and may include the name of the videogame 126 recorded during gameplay, the section of the videogame 126 recorded during gameplay, and/or a date gaming information was created.

In one embodiment, peer-rating information may be stored in an automatically generated descriptive tag 212. As other gamers obtain and use gaming information 214 created by the gamer 22, the other gamers may rate the usefulness of the gaming information 214. This gaming information 214 may be automatically added to the descriptive tag 208 by the gaming information exchange server 134 at any time.

In another embodiment, as illustrated in FIG. 3B, the gaming information 214 and the descriptive tag 208 may be stored in separate data structures 252, 256. A first data structure 256 may contain the gaming information 214 as described above. A second data structure 252 may contain one or more descriptive tags 208 as described above, and may further contain location information 254 about the location of the data structure 256 containing the gaming information 214. Storing the gaming information 214 and the descriptive tag 208 in separate data structures 252, 256 may allow for storage of the data structures 252, 256 in separate locations.

In one embodiment, a data structure 200 may contain gaming information 214 and one or more descriptive tags 208, where the gaming information 214 constitutes gamer inputs 202 into a gaming system 102 and visual outputs 204 of the gaming system 102 but not gameplay parameters 206. The gameplay parameters 206 may not exist or may not be extractable from the videogame 126. Alternatively, a gameplay parameter 206 may be stored as an automatically generated descriptive tag 212.

### Recording to the Data Structure

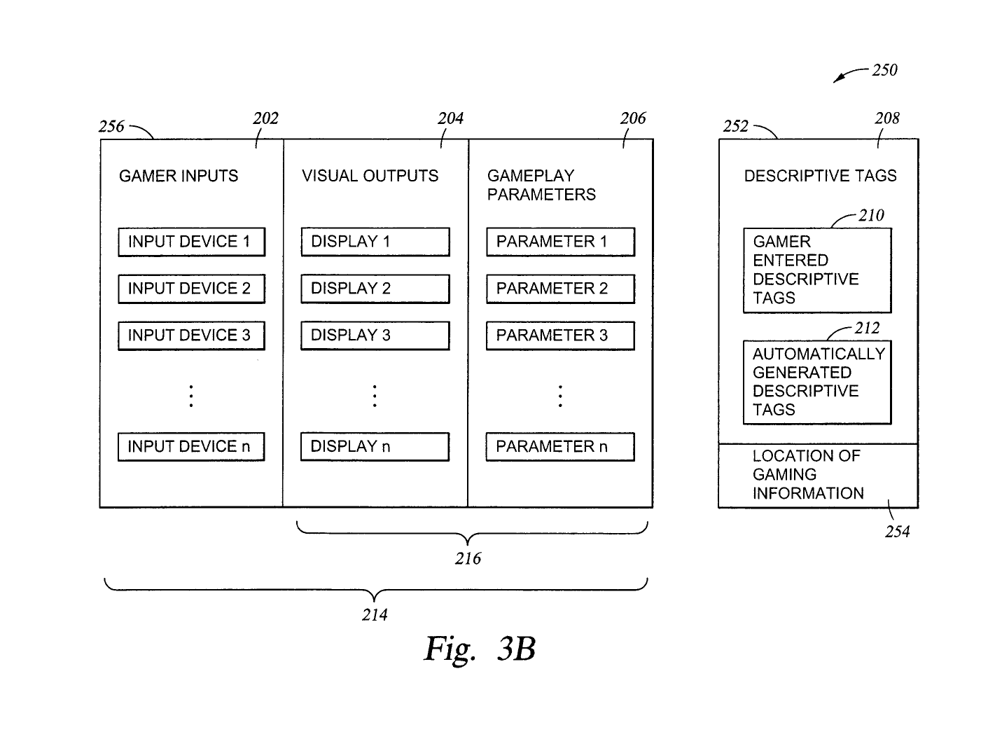

FIG. 4 is a flow diagram depicting a process 1100 for the creation of the data structure 200 for storing gaming information 214 and at least one descriptive tag 208, according to one embodiment of the invention. Recording of gaming information may begin at 1102 when the recording application 132 on the gaming system 102 creates a new gaming information data structure 200. As the gamer 22 begins playing the videogame 126, the recording application 132 records 1104 the gamer inputs 202 into the gaming system 102 by storing such inputs into the data structure 200. From the gamer inputs 202, the gaming system 102 may determine 1106,1108 the visual output 204 and gameplay parameters 206, and may record them into the data structure 200. Process 1100 may return to 1104 until the recording of gameplay has ceased. Once the determination has been made that gameplay has ceased 1110, one or more automatically generated descriptive tags 212 and gamer-entered descriptive tags 210 may be entered 1112.

In another embodiment, one or more automatically generated descriptive tags 212 and gamer-entered descriptive tags 210 may be entered immediately after the creation of the data structure 200 and before the start of gameplay.

In one embodiment, a gamer 22 may explicitly initiate recording with the recording application 132. Alternately, the recording application 132 may begin and terminate recording automatically as dictated by some programmatic inputs (e.g., on the basis of a pending request from another gamer 20 for specific gaming information, as will be described in more detail below).

In one embodiment, recording of gaming information 214 may be initiated by the gamer 22 and stored locally on the gaming system 102. The gamer 22 may not make the gaming information 214 available to other gamers, but rather may use the locally stored gaming information 214 for personal use. For example, the gamer may use the locally stored gaming information 214 to gauge improvement in gaming skills, remember how the gamer played a section 302 of a videogame 126, and/or show friends of the gamer how the gamer performed while playing a section 302 of a videogame 126. The section 302 may be any portion of the videogame 126, including a specific level or mission, a specific objective, a secret shortcut, or the whole videogame 126.

### Process Initiated by a Gamer Request for Gaming Information

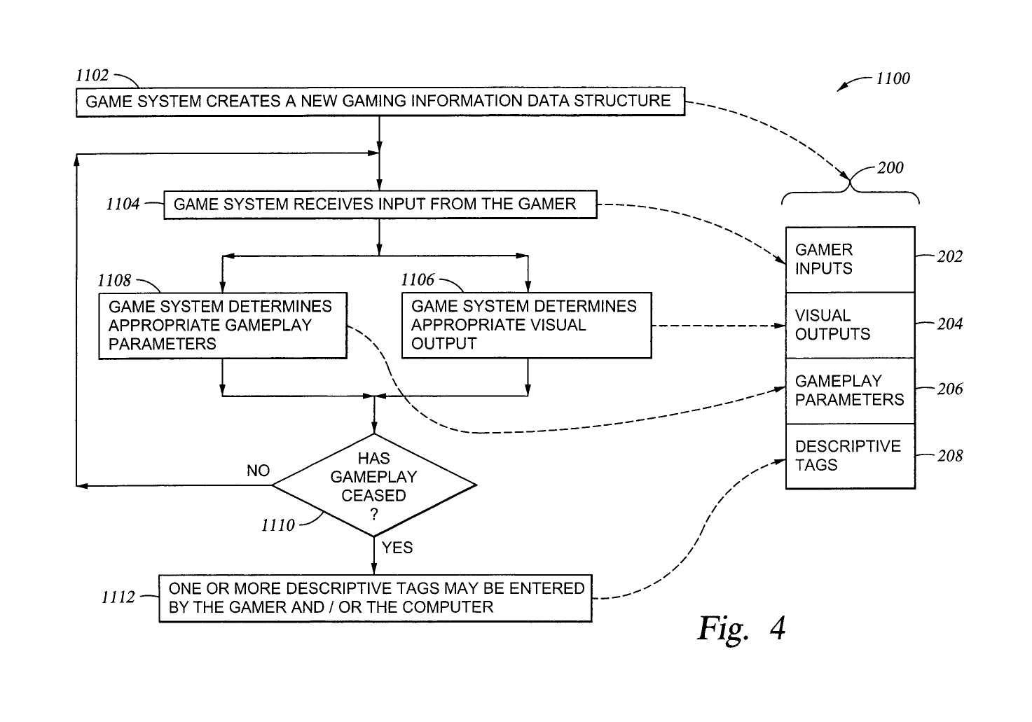

FIG. 5 is a flow diagram depicting a process 1300 for requesting, creating, and obtaining gaming information 214, according to one embodiment of the invention. The process may begin at 1302 where a first gamer 20 desires information about a videogame 126 or a section of the videogame 126. The first gamer 20 may search a gaming information exchange server 134 for existing recorded gaming information 214 related to the videogame 126, as in 1304. The gaming information exchange server 134 may be part of a gaming information exchange where gamers may obtain gaming information 214.

In one embodiment, if the related gaming information 214 is present 1306 on the gaming information exchange server 134, the first gamer 20 may purchase the related gaming information 214 as in 1308. In 1310, the first gamer 20 may download and review the purchased gaming information 214. After reviewing the purchased gaming information 214, the first gamer 20 may rate the gaming information's usefulness 1312. After reviewing and rating the purchased gaming information 214, the first gamer 20 may return to gameplay 1312 and attempt to implement the knowledge gained from the purchased gaming information 214. Alternatively, the first gamer 20 may attempt to implement the knowledge gained from the purchased gaming information 214 prior to rating the gaming information 214.

In one embodiment, if the related gaming information 214 is not present 1306 on the gaming information exchange server 134, the first gamer 20 may elect to store the request for gaming information 214 in 1316. The request for gaming information 214 may include not only the specific videogame 126 and section of the videogame 126, but also a desired skill-level and peer-rating.

In one embodiment, when a second gamer 22, playing at the desired skill-level, reaches the section of the videogame 126 about which the first gamer 20 seeks gaming information 214, as in 1318, the second gamer 22 may be prompted to record gaming information 1320 during gameplay 1320.

In one embodiment, if the second gamer 22 declines the prompt 1321 to record the requested section of gameplay, the second gamer 22 may return to gameplay 1322.

In one embodiment, if the second gamer 22 accepts the prompt 1321 to record the requested section of gameplay, the second gamer's gameplay continues while being recorded 1324 as is described in process 1100.

In one embodiment, once the second gamer 22 has completed recording gaming information 214, the second gamer may be prompted to determine if he/she is satisfied with his/her performance in the recorded gaming information 214, as in 1326.

In one embodiment, if the second gamer 22 is not satisfied with his/her performance in the recorded gaming information 214, the gaming information 214 may not be stored 1328 and the second gamer may return to gameplay 1322.

In one embodiment, if the second gamer 22 is satisfied with his/her performance in the recorded gaming information 214, the gaming information 214 may be stored 1330 on the gaming information exchange server 134, and the second gamer 22 may return to gameplay 1322. Alternatively, the gaming information 214 may be stored 1330 locally on the gaming device.

In one embodiment, when the second gamer's gaming information 214 is stored 1330 on the gaming information exchange server 134, a message is sent 1332 to the first gamer 20 alerting him/her of the new gaming information. The process 1300 may return to 1304, where the first user 20 can again search for the desired recorded gaming information 214.

### Example of Process Initiated by a Gamer Request for Gaming Information

### Gamer Request for Gaming Information

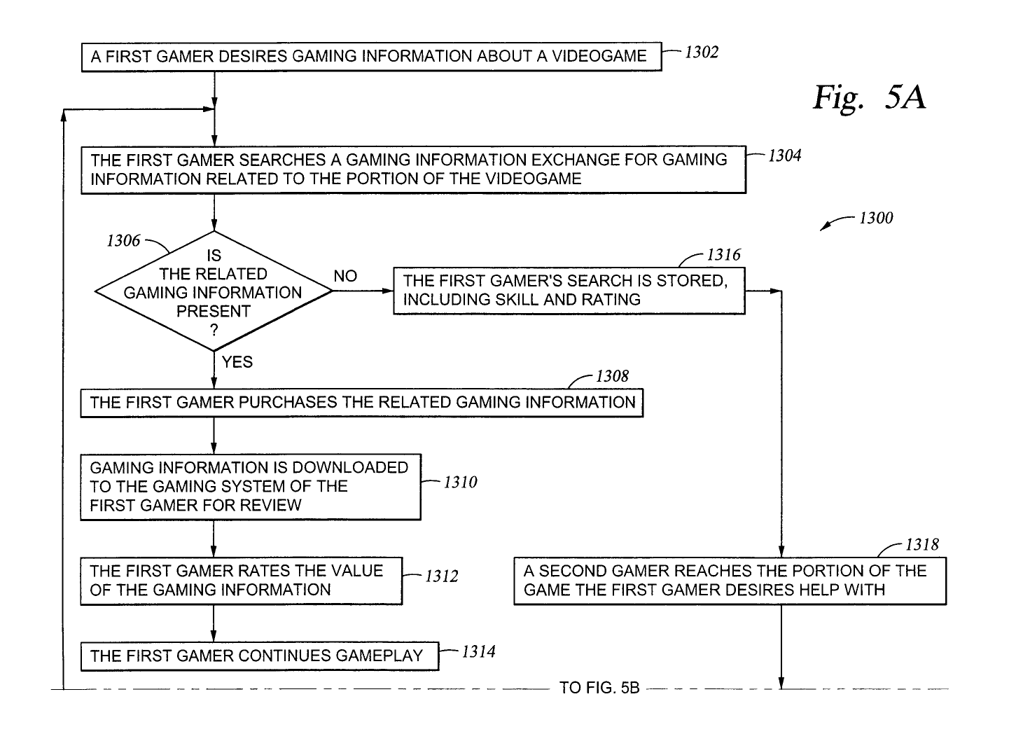

FIGS. 6-18 show a plurality of graphical user interfaces (GUIs) for implementing the process 1300. FIG. 6 is a block diagram illustrating a GUI 300 displaying an in-game prompt 304 a first gamer 20 may receive when requesting gaming information 214 for a section 302 of a videogame 126, according to one embodiment of the invention. While playing the videogame 126, the first gamer 20 may be unable to proceed past the certain section 302 in the videogame 126 and may desire gaming information 214 related to the section 302 in the videogame 126. Accordingly, the first gamer 20 may signal the desire for the related gaming information 214 to the gaming system 102 and the system may respond by suspending gameplay and prompting 304 the first gamer 20 to view available gaming information 214. Alternatively, playing may not suspend.

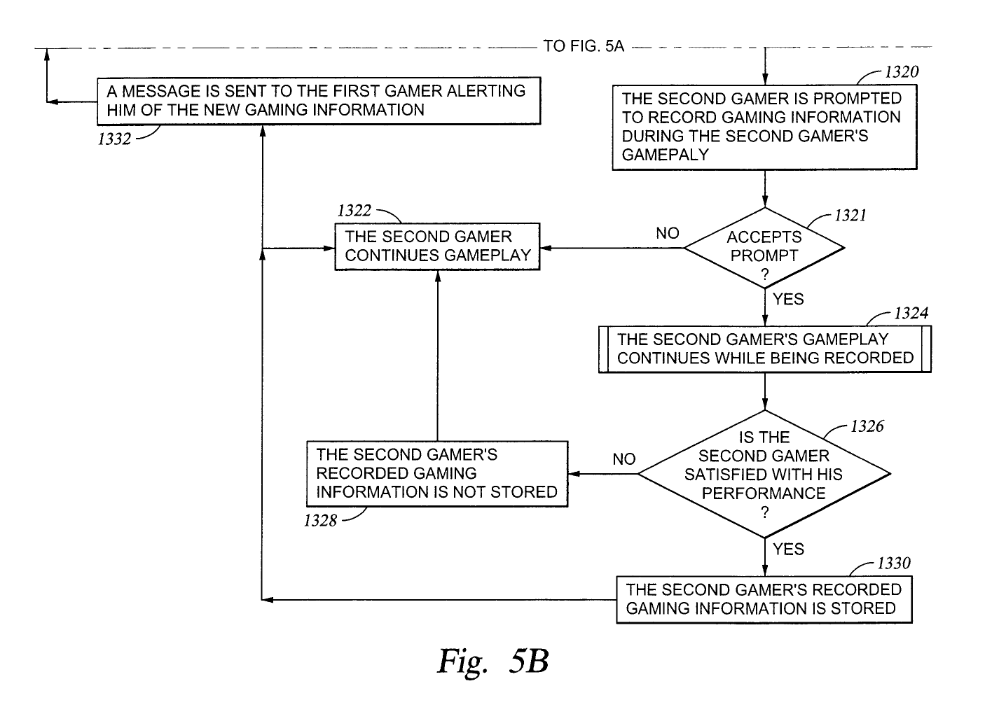

In one embodiment, if the first gamer 20 elects to view available gaming information 214, the browsing application 124 may open and display to the first gamer 20 a webpage 146 containing references 404 to a plurality of gaming information 214, as can be seen in GUI 400 of FIG. 7. The table 402 of the GUI 400 may contain the plurality of gaming information 214 related to the section 302 in the videogame 126. Details 410 about each of the plurality of gaming information 214 in the table 402 may be included. For example, details 410 may include a name 408 of the videogame 126, a particular section 302 in the videogame 126, a date 412 the gaming information 214 was created, a skill-level 414 of the recorded gaming information 214, and/or a peer-rating 416 of the quality of the gaming information 214. If the desired gaming information 214 related to the section 302 in the videogame 126 is found, the first gamer 20 may elect to purchase the gaming information 214 related to the section 302. If the desired gaming information 214 is not found, the first gamer 20 may request with an on screen button 406 that a second gamer 22 record the desired gaming information 214, as is described in more detail below.

In one embodiment, the first gamer 20 may be able to obtain partial gaming information 214 instead of complete gaming information 214. In turn, the partial gaming information 214 may cost less than complete gaming information 214 and/or may be contained in a smaller file that may be downloaded to the first gamer's gaming system 102 in a shorter amount of time. For example, the first gamer 20 may desire the recorded inputs 202 and visual outputs 204 of a second gamer 22, but may not desire gameplay parameters 206.

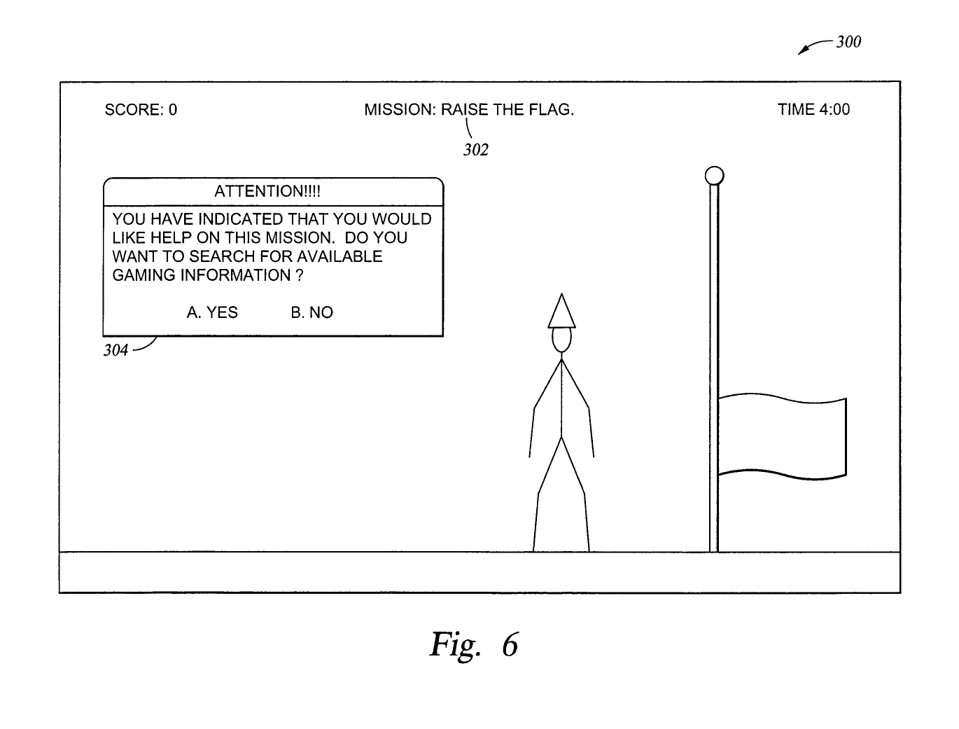

In one embodiment, if, in FIG. 7, the first gamer 20 elected to view more details about specific gaming information 418, the browsing application 124 may display to the first gamer 20 a webpage 146 containing information pertaining to the specific gaming information 418, as can be seen in GUI 450 of FIG. 8. In the GUI 450, the first gamer 20 may be prompted 452 to purchase the specific gaming information 418. The prompt 452 may include the cost of the gaming information 456 as well as an option to finalize the purchase or cancel the transaction 458. The webpage 146 may also include a screenshot 460 of the specific gaming information 418.

### System for Reviewing Gaming Information

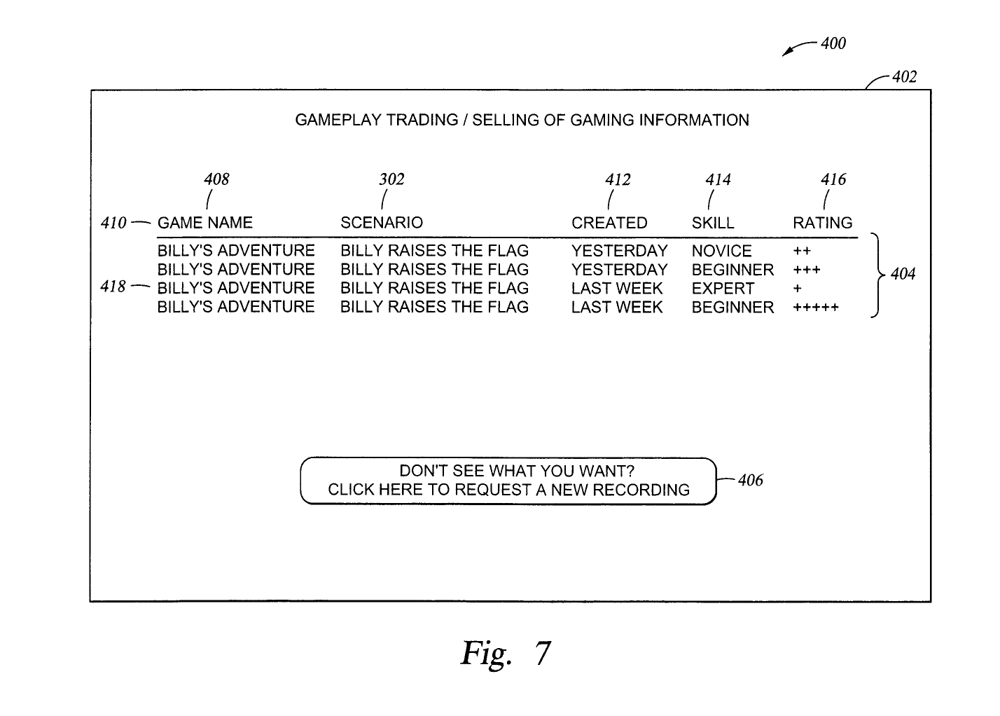

In one embodiment, if, in FIG. 8, the first gamer 20 purchased the specific gaming information 418, the browsing application 124 may close, and the reviewing application 120 may open. The reviewing application 120 may begin playback of the specific gaming information 418, as in GUI 500 in FIG. 9. Reviewing gaming information 214 constitutes playback of the gaming information 214, including the recorded gamer inputs 202, the visual outputs 204 of the gaming system 102, and the gameplay parameters 206.

In one embodiment, the GUI 500 may contain a representation 504 of the recorded gamer inputs 202 found in the specific gaming information 418. The representation may include a depiction of a gaming input device 506 and buttons pressed on the device 508, 510 to produce a visual output 516 and gameplay parameters 512, 514 of the specific gaming information 418 being reviewed by the gamer. The GUI 500 may also contain a notification 502 indicating that the gaming system 102 is playing recorded gaming information 418 and that the gameplay is currently suspended.

In one embodiment, separate systems may be used for the recording and playback of gaming information 214. For example, the gaming system 102 may be used to record gaming information 214, and a personal computer that is not the gaming system 102 may be used to access the gaming information exchange server 134, purchase and download gaming information 214, and review the purchased gaming information 214.

### System for Recording Gaming Information

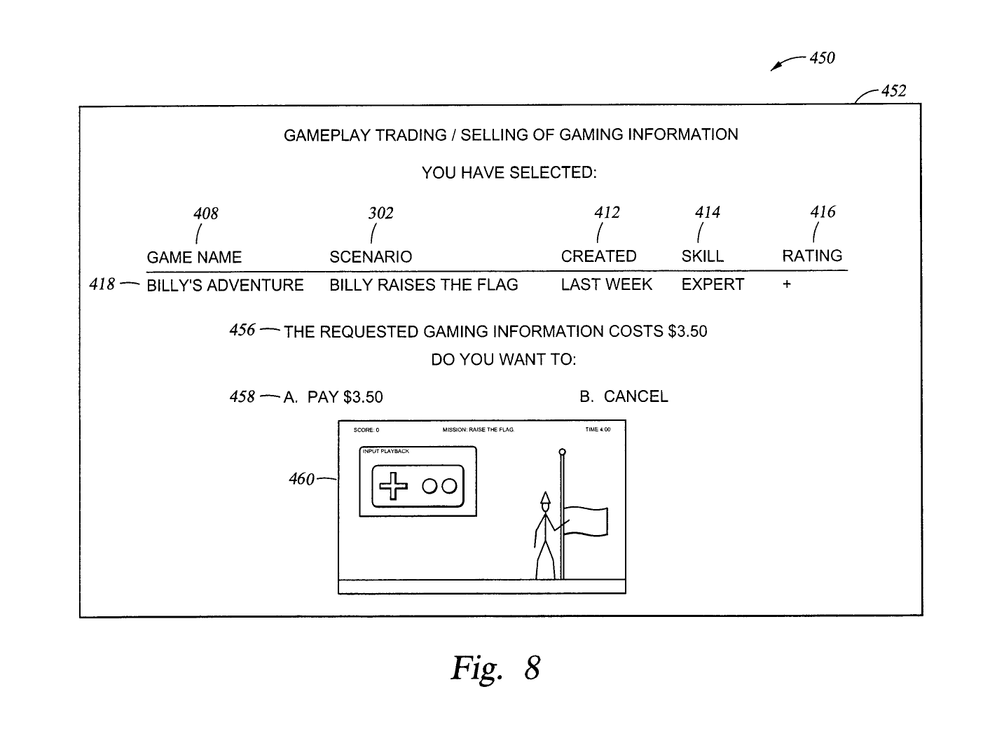

In one embodiment, if, in FIG. 7, the first gamer 20 requested with the on screen button 406 that a second gamer 22 record gaming information 214 for the section 302 of the videogame 126, the request 12 may be sent via the network 160 to the gaming information exchange server 134. If a second gamer 22 has elected to receive such requests 12 from the gaming information exchange server 134, and the system 102 of the second gamer 22 has a connection to the network 160, the second gamer 22 may receive an in-game prompt 602 to record gameplay when playing the section 302 of the videogame 126, as is illustrated in the GUI 600 in FIG. 10. Optionally, the prompt to record gameplay could be a small, non-obtrusive, icon 604 in the corner of the GUI 600, which would indicate the presence of the request 12 without suspending gameplay.

In one embodiment, the second gamer 22 may respond to the prompt 602 either by allowing or not allowing the recording of his/her gameplay. After the second gamer 22 responds to the prompt 602, gameplay continues. Alternatively, the second gamer 22, may activate the recording application 132, record gameplay, and post gaming information 214 to the gaming information exchange server 134 without first being prompted, as will be discussed in more detail below.

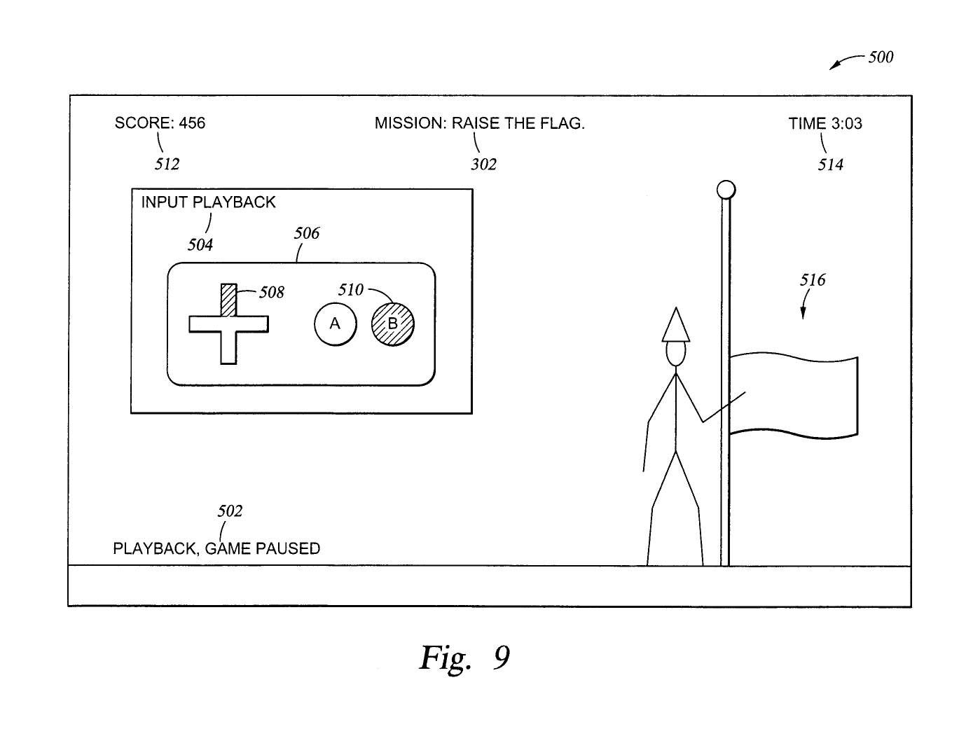

FIG. 11 is a block diagram illustrating an empty data structure 1200 for storing gaming information 214 and at least one descriptive tag 208. FIG. 11 may exemplify the data structure 1200 created when the second gamer 22 elects to record gaming information 214, whether or not the election is in response to a prompt 602.

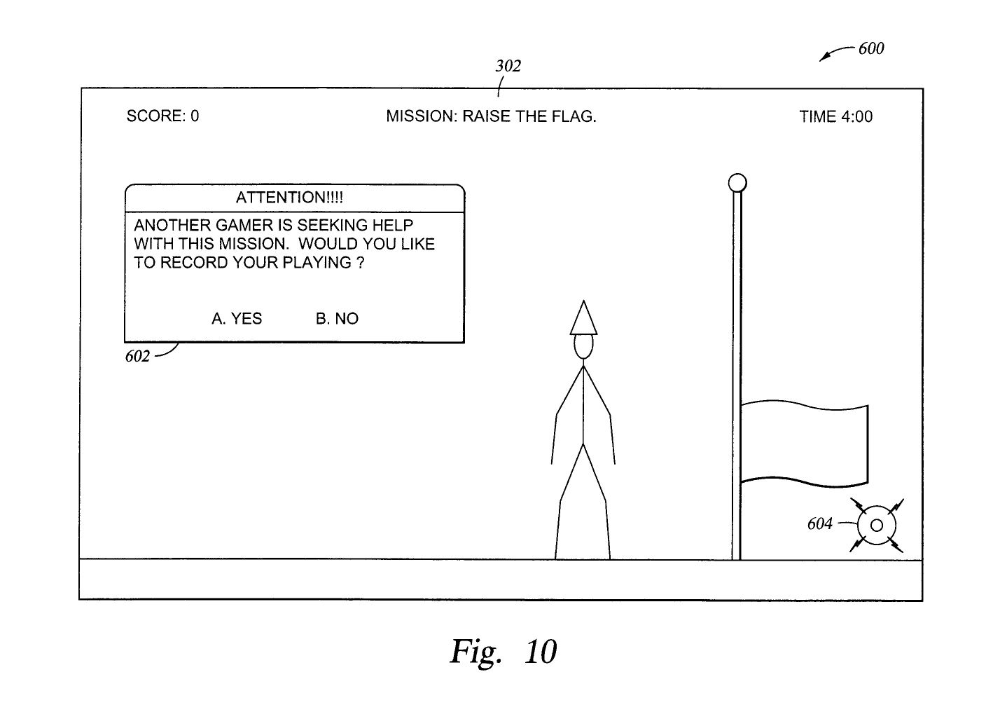

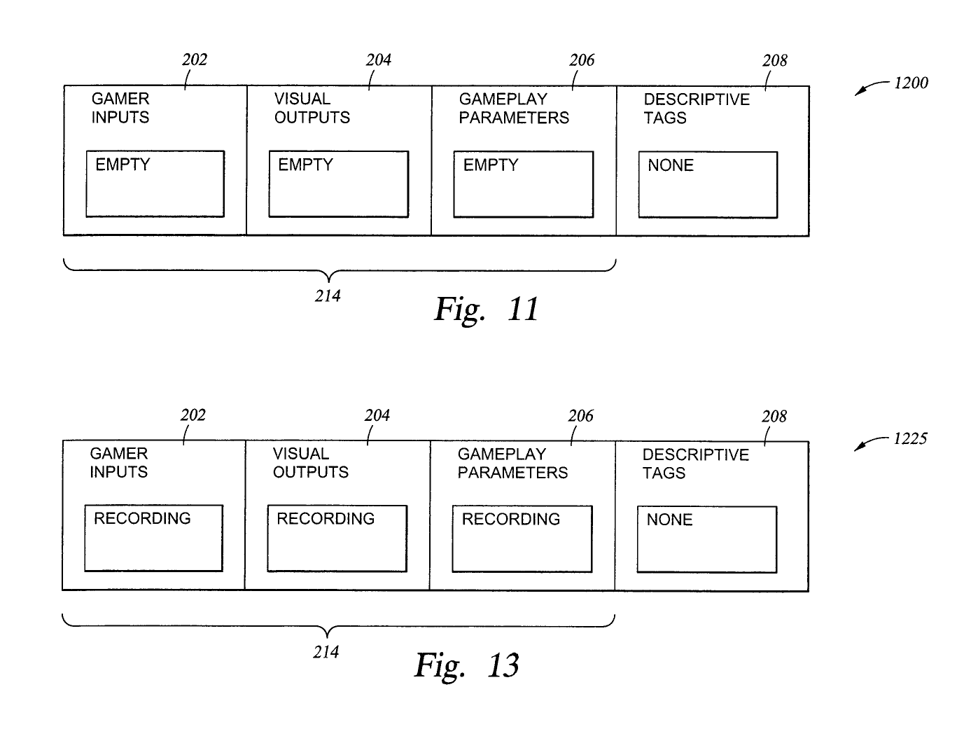

FIG. 12 is a block diagram illustrating a GUI 700 depicting the gameplay of the second gamer 22 as he/she records gameplay with the recording application 132. A notification 702 indicating that the gaming system 102 is recording gameplay may be present in the visual output 204 of the section 302 of the videogame 126 while the second gamer is recording the gaming information 214 requested by the first gamer 20. As described above, the gamer inputs 202 into the gaming system 102 during gameplay may be recorded. The gamer inputs 202 may be processed by the gaming system 102 and the visual outputs 204 and gameplay parameters 206 may be determined and recorded. FIG. 13 may exemplify the data structure 1225 to which gaming information 214 is being written while the second gamer 22 records his/her gameplay.

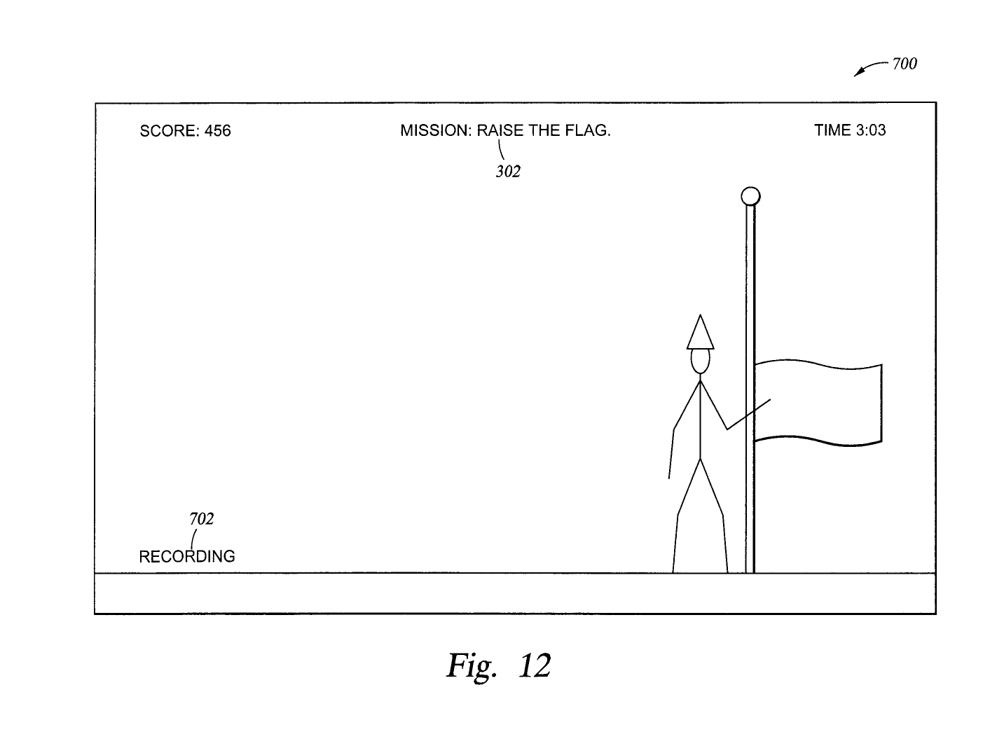

FIG. 14 is a block diagram illustrating a GUI 800 displaying the completion of the section 302 of the videogame 126 played by the second gamer 22, according to one embodiment of the invention. A notification 806 may be displayed by the videogame 126 indicating that the section 302 of the videogame 126 was successfully completed. A notification 804 indicating that the system has stopped recording gameplay 804 may be present in the visual output 204 of the section 302 of the videogame 126.

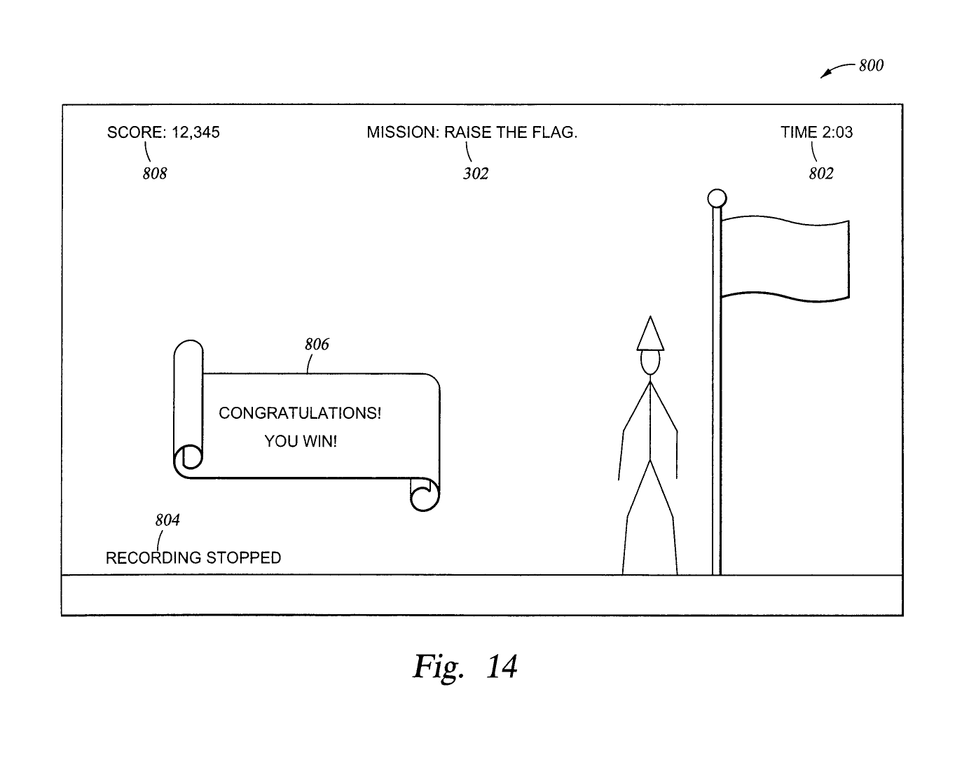

In one embodiment, upon completion of the second gamer's gameplay, the gamer inputs 202, the visual outputs 204, and the gameplay parameters 206 may be stored in the data structure 200, as is exemplified by an incomplete data structure 1250 in FIG. 15. The gameplay parameters 206 time 802, score 808, and skill-level of the recording are illustrated in the gameplay parameter portion 1252 of the data structure 1250.

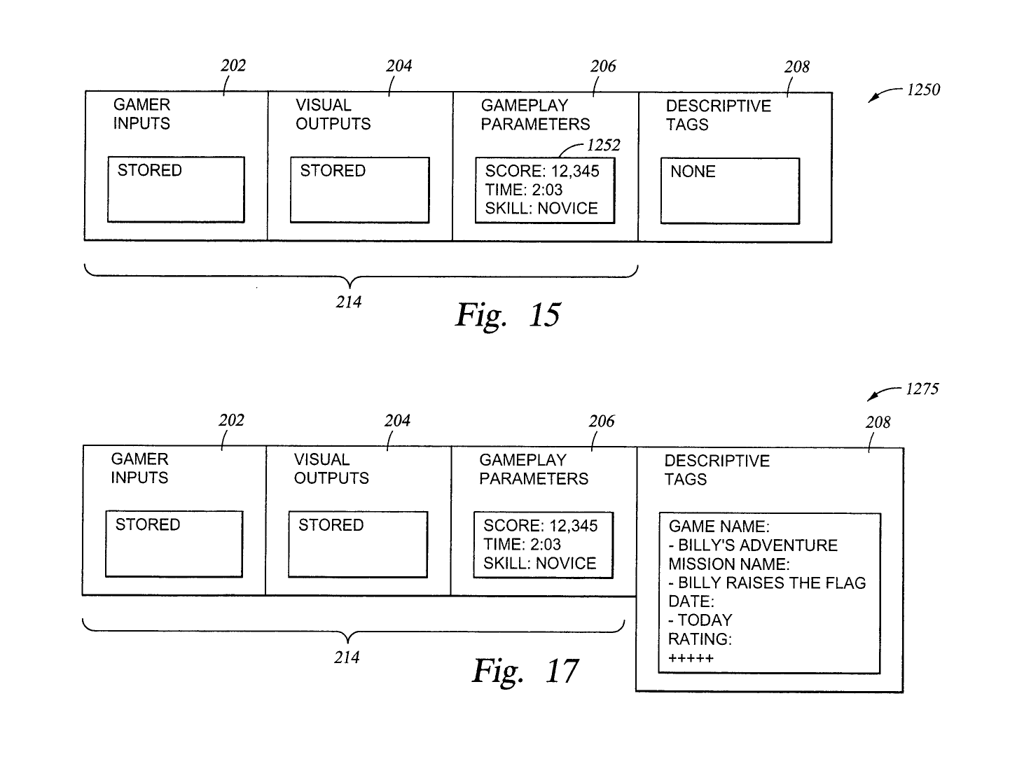

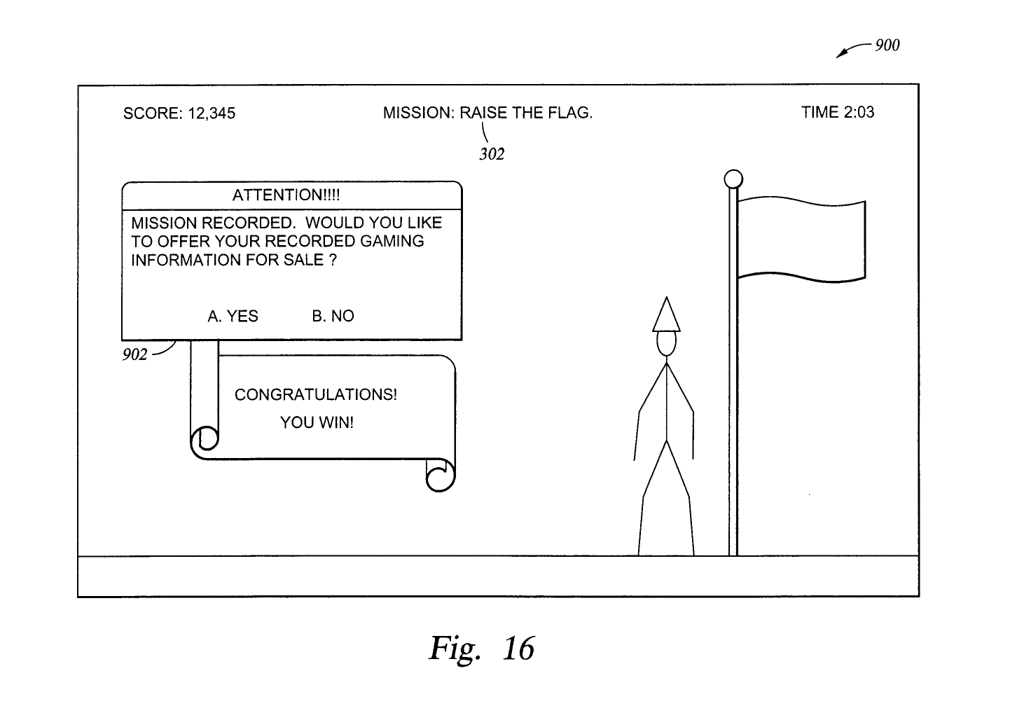

FIG. 16 is a block diagram illustrating a GUI 900 displaying an in-game prompt 902 the second gamer 22 may receive after completion of the section 302 of the videogame 126, according to one embodiment of the invention. The prompt 902 may alert the second gamer 22 that the section 302 of the videogame 126 requested by the first gamer 20 was successfully recorded. Furthermore, the prompt 902 may ask the second gamer 22 whether or not to submit the recorded gaming information 214 for sale. If the second gamer 22 elects to offer the gaming information 214 for sale, automatically generated descriptive tags 1276 may be written to the data structure 1275, as may be illustrated in FIG. 17. Alternatively, one or more gamer-entered descriptive tags 210 may be entered by the second gamer 22.

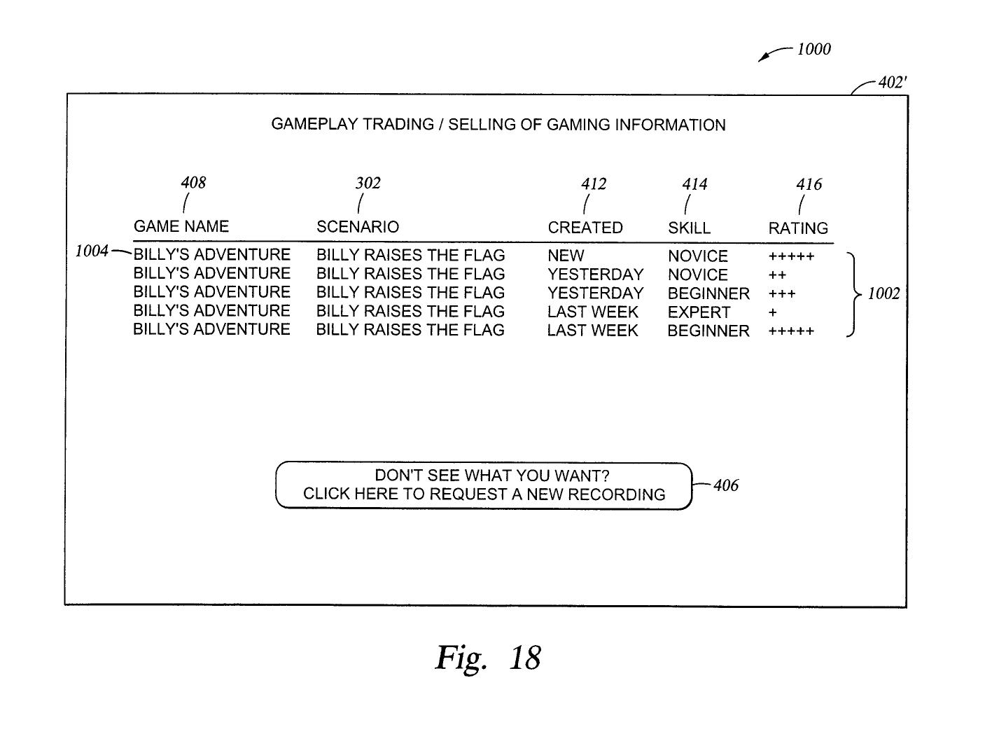

FIG. 18 is a block diagram illustrating a GUI 1000 containing updated references 1002 to the plurality of gaming information 214, including the gaming information newly created 1004 by the second gamer 22, according to one embodiment of the invention. The GUI 1000 represents the webpage the first gamer 20 would receive when the first gamer 20 requests gaming information 214. The updated table 402′ contains the same results as in FIG. 7, with the noted addition of the gaming information 1004 recorded by the second gamer 22.

In one embodiment, the second gamer 22 may be required to register as a gaming information provider 22. The gaming information provider 22 may further indicate for which videogames 126 he/she will be the provider. In this manner, a requesting gamer 20 can browse an index on the gaming information exchange server 134 to see which videogames 126 may be currently supported (e.g., for which videogames 126 at least one gamer 22 has registered as a provider).

In one embodiment, the gaming information provider 22 may indicate his/her skill level, highest score achieved, and/or highest level reached for a given videogame 126. This information may aid the requesting gamer 20 in determining whether the gaming information provider 22 has the requisite skill to generate the gaming information 214 the requesting gamer 20 desires.

In one embodiment, the act of the requesting gamer 20 posting a request 12 for gaming information 214 on the gaming information exchange server 134 may trigger the sending of a message to the registered gaming information provider 22. Upon receiving the request 12 the gaming information provider 22 may elect to play the videogame 126 to generate the requested gaming information 214, and then may transmit to the requesting gamer 20 (either directly or via the gaming information exchange server 134) the requested gaming information 214.

Thus, in one embodiment, a made-to-order model is contemplated in which the requesting gamer 20 may be akin to a student and the gaming information provider 22 may be akin to a mentor. Of course, it is also contemplated that the gaming information 214 desired by a requesting gamer 20 may already be available from the gaming information exchange server 134, in which case the requesting gamer 20 need only purchase the gaming information 214.

### Process Initiated by a Gamer Request to Store Gaming Information

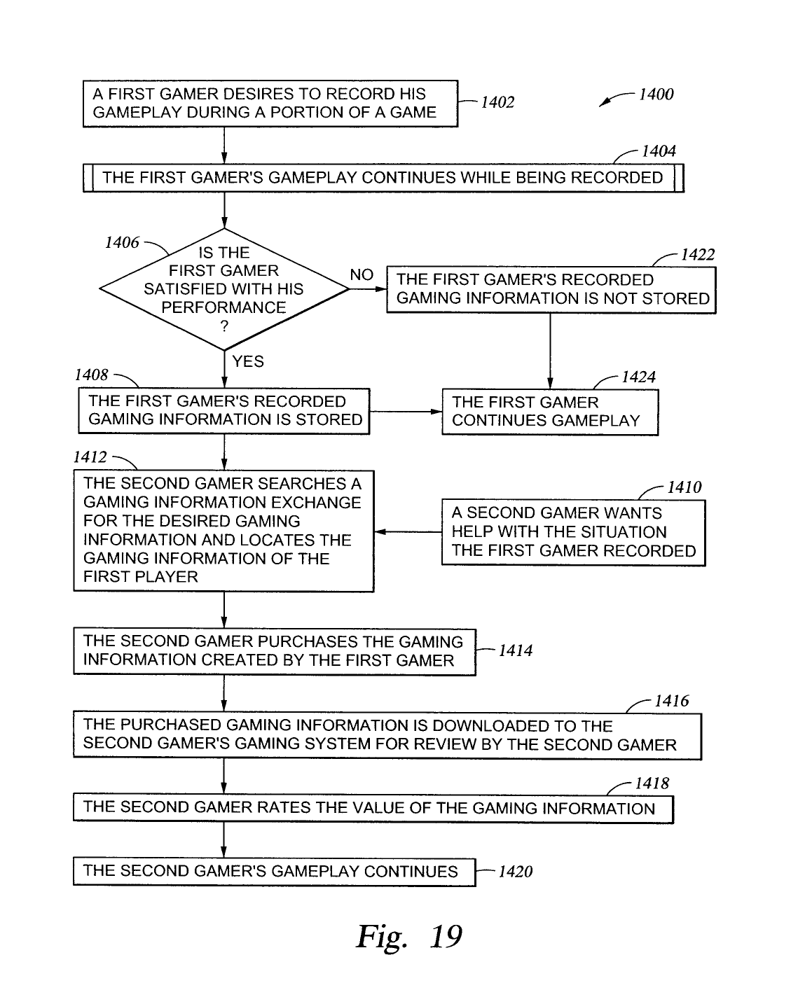

As stated above, a gamer, who may be a first gamer, may decide to initiate recording of gaming information 214 without being prompted by the system. FIG. 19 is a flow diagram depicting a process 1400 for creating, and obtaining gaming information 214, according to one embodiment of the invention. The process may begin at 1402 where a first gamer desires to record his/her gameplay during a section 302 of a videogame 126. The first gamer's gameplay continues while being recorded 1404 as in process 1100.

In one embodiment, once the first gamer has completed recording gaming information 214 for the section 302 of the videogame 126, the first gamer may be prompted 902 to determine if he/she is satisfied with his/her performance in the recorded gaming information 214, as in 1406.

In one embodiment, if the first gamer is not satisfied with his/her performance in the recorded gaming information 214, the gaming information 214 may not be stored 1422 and the first gamer may return to gameplay 1424.

In one embodiment, if the first gamer is satisfied with his/her performance in the recorded gaming information 214, the gaming information 214 may be stored 1408 on the gaming information exchange server 134, and the first gamer may return to gameplay 1424.

In one embodiment, a second gamer may desire information about the section 302 of the videogame 126 for which the first gamer recorded gaming information 214 as in 1410. The second gamer may search 1412 the existing recorded gaming information 214 on the gaming information exchange server 134 and may locate the first gamer's recorded gaming information 214. The gaming information exchange server 134 may be part of a gaming information exchange where gamers may obtain gaming information 214.

In one embodiment, the second gamer may purchase the gaming information 214 created by the first gamer 1414. After downloading and reviewing 1416 the purchased gaming information 214, the second gamer may rate the gaming information's usefulness 1418. After reviewing and rating the gaming information 214, the second gamer may return to gameplay 1420 and attempt to implement the knowledge gained from the first gamer's recorded gaming information 214. Alternatively, the second gamer may attempt to implement the knowledge gained from the first gamer's recorded gaming information 214 prior to rating the gaming information 214.

### Process for Storing Outstanding Gaming Information

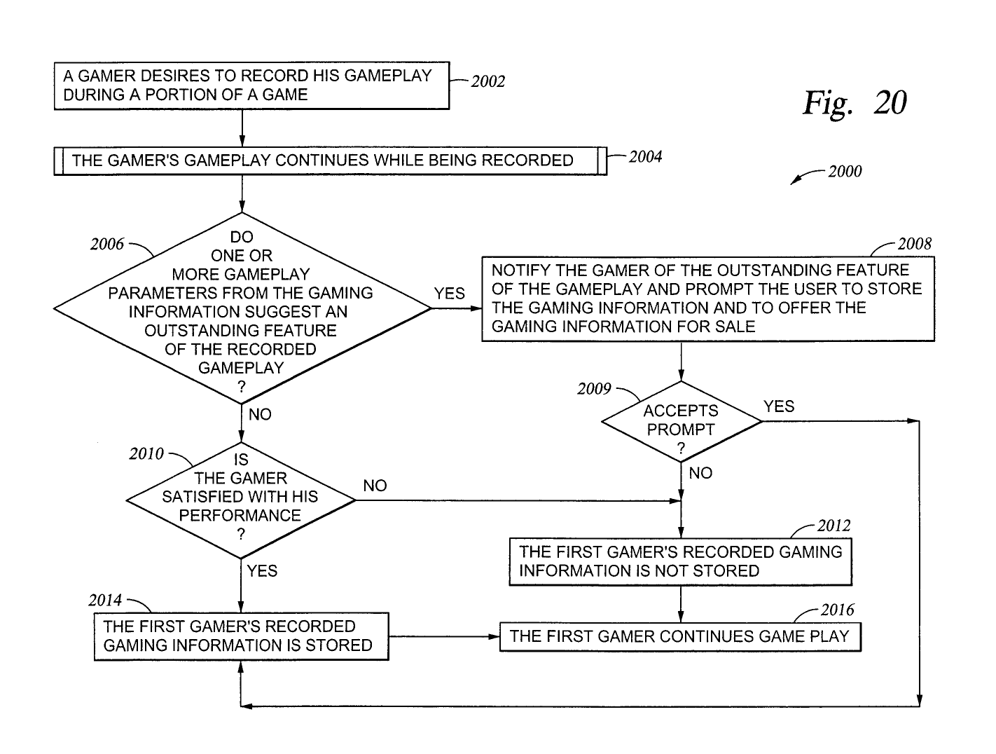

FIG. 20 is a flow diagram depicting a process 2000 for creating and storing gaming information 214, according to one embodiment of the invention. The process may begin at 2002 where a gamer desires to record his/her gameplay during a section 302 of a videogame 126. The gamer's gameplay continues while being recorded 2004 as in process 1100.

In one embodiment, once the gamer has completed recording gaming information 214 for the section 302 of the videogame 126, a determination may be made, as in 2006, as to whether or not any of the gameplay parameters 206 suggest an outstanding feature of the recorded gameplay. For example, the outstanding feature may include a high score at the end of a level, the most kills during a level, the fewest times killed while playing a level, and/or discovery of hidden bonuses. The detection of the outstanding feature may be performed by the recording application 132 on the gaming system 102 and/or the gaming information exchange server 134 in communication with the recording application 132. Furthermore, the determination that a feature of gameplay is outstanding may be based on a value of the gameplay parameter 206 never before achieved, or simply recognition that a gamer had to be skilled to obtain such an outstanding gameplay parameter 206. Further, the outstanding feature may be specific to the particular gamer (e.g., a personal high score) or may be determined with respect to statistics maintained by the exchange server 134 (e.g., highest recorded score for all gamers registered with the exchange server 134).

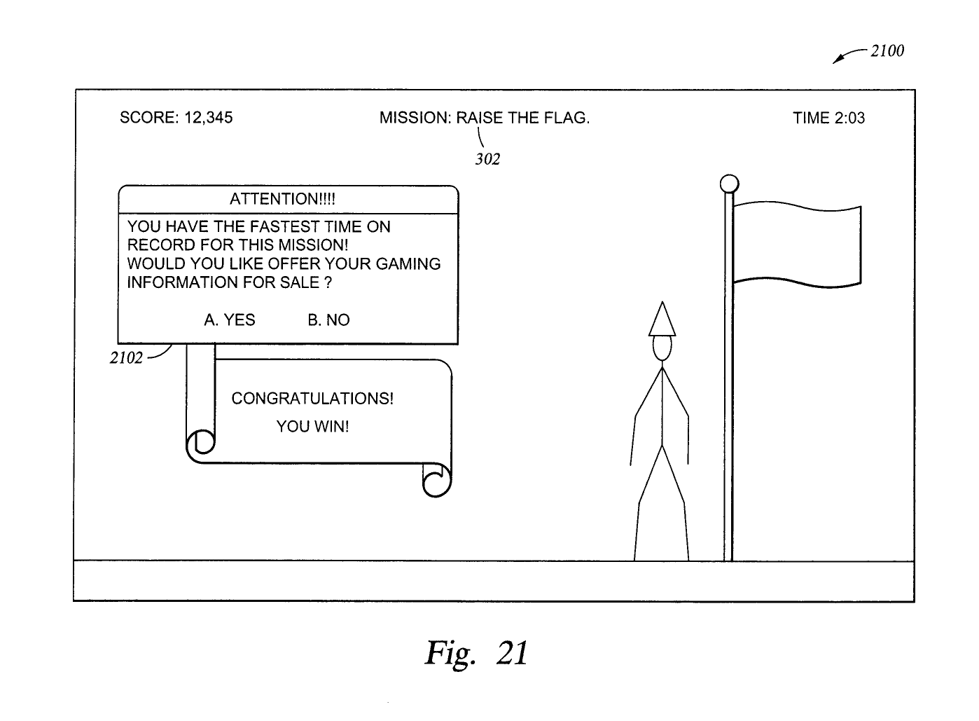

In one embodiment, depicted in a GUI 2100 in FIG. 21, if an outstanding gameplay parameter is detected in 2006 while playing a section 302 of a videogame 126, the gamer may be notified of the outstanding gameplay parameter, and prompted by prompt 2102 to determine if he/she would like to offer the recorded gaming information 214 for sale, as described in step 2008 of FIG. 20.

In one embodiment, if the gamer declines the prompt 2009 to offer the recorded gaming information 214 for sale, the gaming information 214 may not be stored 2012 and the gamer may return to gameplay 2016.

In one embodiment, if the gamer accepts the prompt 2009 to offer the recorded gaming information 214 for sale, the gaming information 214 may be stored 2014 on the gaming information exchange server 134, and the gamer may return to gameplay 2016.

In one embodiment, if no outstanding gameplay parameter is detected in 2006, the gamer may be prompted 902 to determine if he/she is satisfied with his/her performance in the recorded gaming information 214, as in 2010.

In one embodiment, if the gamer is not satisfied with his/her performance in the recorded gaming information 214, the gaming information 214 may not be stored 2012 and the gamer may return to gameplay 2016.

In one embodiment, if the gamer is satisfied with his/her performance in the recorded gaming information 214, the gaming information 214 may be stored 2014 on the gaming information exchange server 134, and the gamer may return to gameplay 2016.

In one embodiment, the recording application 132 on the gaming system 102 may initiate the recording of gaming information 214 without notifying the gamer. Such recording may occur in the background and may not be subsequently stored on the gaming information exchange server 134 unless an outstanding gameplay parameter 206 is detected, as described above.

### Gaming Information Exchange

In one embodiment, a gaming information exchange 1304, 1412 may be a computer network 160 based file exchange service, an embodiment of which is depicted in FIGS. 1 and 2. The gaming information exchange server 134 may store a plurality of data structures 200 that contain gaming information 214 as well as one or more descriptive tags 208. Thus, the gaming information exchange 1304, 1412 may be centrally run by one or more gaming information exchange servers 134.

In one embodiment, the gaming information exchange server 134 may store a plurality of data structures 252 (illustrated in FIG. 3B) that contain one or more descriptive tags 208 as well as a location 254 of a data structure 256 (illustrated in FIG. 3B) which contains gaming information 214. Thus, the gaming information exchange 1304, 1412 may be distributed over one or more gaming systems 102 and one or more gaming information exchange servers 134, as may be the case with a peer-to-peer file exchange service.

In one embodiment, a gaming information exchange 1304, 1412 may be a computer network 160 based service, for distributing requests for gaming information, an embodiment of which is depicted in FIGS. 1 and 2. The gaming information exchange server 134 may store a request 12 from a requesting gamer for gaming information 214. The gaming information exchange server 134 may distribute the request 12 to other gamers. The other gamers may then create gaming information 214 that satisfies the request 12 and may store the gaming information on the gaming information exchange server 134, or may send the gaming information 214 directly to the requesting gamer.

In one embodiment, the gaming information exchange 1304, 1412 may be a computerized auction environment. Gamers may post recorded gaming information 214 on the computerized auction environment for other gamers to locate and bid on. Upon completion of an auction, the computerized auction environment may notify one or both of the winner of the auction and the seller of the gaming information 214 of the other's contact information so that a transaction may occur. Examples of this type of computerized auction environment include eBay.com® (eBay.com is a trademark of eBay Inc. in the US, other countries, or both) and uBid.com® (uBid is a trademark of uBid, Inc. in the US, other countries, or both).

In one embodiment, the gaming information exchange 1304, 1412 may operate as an online store that sells gaming information 214 as its product. In this commercial environment, gamers may search for and purchase gaming information 214 directly from the online store. The online store may obtain gaming information 214 by paying or offering store credit to gamers for their recorded gaming information 214. Optionally, the online store may employ garners to generate the gaming information 214. Examples of online stores include Amazon.com® (Amazon.com is a trademark of Amazon.com, Inc. in the US, other countries, or both), BestBuy.com® (BestBuy.com is a trademark of Best Buy Concepts, Inc. in the US, other countries, or both), and Wal-Mart.com® (Wal-Mart.com is a trademark of Wal-Mart Stores, Inc. in the US, other countries, or both).

In one embodiment, the gaming information exchange 1304, 1412 may operate as a decentralized peer-to-peer file sharing network, e.g., Gnutella or Kazaa® (Kazaa is a trademark of Sharman License Holdings Limited in the US, other countries, or both). In this manner, gaming information 214 may be stored on the gaming system 102 of the gamer that created the gaming information 214, and may be located and downloaded by other garners without the need for searching a central repository of gaming information 214.

In one embodiment, the gaming information exchange 1304, 1412 may periodically offer gaming information 214 for free, for example, as a promotion to bring in new customers or for outdated gaming information 214. Similarly, in one embodiment, the gaming information exchange 1304, 1412 may offer credit to garners that contribute their own recorded gaming information 214.

### Further Embodiments

Embodiments of the present invention are described above with respect to garners recording gameplay as gaming information 214 and distributing the gaming information 214 to other garners via a gaming information exchange. However, embodiments of the present invention are not limited to this context or scope.

In one embodiment, the gaming system 102 may be personal computer, and the gaming information 214 may actually be instructional information regarding the operation of software. In this manner, the above described invention may be a tool for training computer users how to use computer software.

In one embodiment, the gaming information 214 may be created by a designer, manufacturer, and/or distributor of the videogame 126. The designer, manufacturer, and/or distributor of the videogame 126 may intend for the gaming information 214 to be used for the purposes described above. Alternatively, the designer, manufacturer, and/or distributor of the videogame 126 may intend for the gaming information 214 to be used as a promotion for a videogame 126, e.g., a pre-release preview to get gamers excited about the videogame 126.

In one embodiment, when creating the videogame 126, the videogame creator may design the videogame 126 in a manner that facilitates use of the above described invention. For example, the videogame creator may include several gameplay parameters 206, may design the videogame 126 so that the above described features are easily implemented, and/or may include a feature so that the gamer can play the videogame 126 while simultaneously viewing recorded gaming information 214 on the gaming system 102.

While the foregoing is directed to embodiments of the present invention, other and further embodiments of the invention may be devised without departing from the basic scope thereof, and the scope thereof is determined by the claims that follow.

What is claimed is:

1. A method of providing gaming information, comprising:
receiving gaming information recorded during gameplay by a user during execution of a gaming application, the gaming information being in an electronic format and being stored on a computer readable storage medium; and
making the gaming information available for sale.

2. The method of claim 1, wherein the gaming information is configured to be executed on a machine and serve as a tutorial to another user.

3. The method of claim 1, wherein the gaming information comprises:
user inputs received by the gaming application during execution of the gaming application; and
outputs produced by the gaming application during execution of the gaming application, wherein the outputs include at least one of visual outputs, audio outputs, gameplay parameters and combinations thereof.

4. The method of claim 1, wherein making the gaming information available for sale comprises:
hosting the gaming information on a web site or in a proprietary application; and
providing instructions to prospective buyers for contacting a seller of the gaming information.

5. The method of claim 1, wherein the gaming information is recorded during gameplay by a process comprising:
recording user inputs received by the gaming application during execution of a segment of gameplay; and
recording outputs produced by the gaming application during execution of the segment of gameplay, wherein the outputs include at least one of visual outputs, audio outputs, gameplay parameters and combinations thereof.

6. A method for recording gaming information comprising:
recording inputs of a user received by a gaming application during execution of a segment of gameplay; and
recording outputs produced by the gaming application during execution of the segment of gameplay, wherein the outputs include at least one of visual outputs, audio outputs, gameplay parameters and combinations thereof.

7. The method of claim 6, wherein the gaming information is associated with one or more descriptive tags that describe characteristics of the gaming information, e.g., a game name or an identification of a segment of gameplay, wherein the one or more descriptive tags are produced by one of: user-entered inputs from the user and automatic generation by the gaming application.

8. The method of claim 7, further comprising assigning a rating to the gaming information based on the content of the gaming information and the content of the one or more descriptive tags associated with the gaming information.

9. The method of claim 6, wherein the recording of gaming information is initiated in response to a prompt to record the segment of gameplay, wherein:
the recorded segment of gameplay corresponds to a pending request for gaming information describing the segment of gameplay; and
the prompt is initiated by one of:
the gaming application; and
an application for recording gaming information.

10. A computer readable storage medium including instructions which, when executed by a processor, perform the method comprising:
receiving gaming information recorded during gameplay by a user during execution of a gaming application, the gaming information being in an electronic format and being stored on a computer readable storage medium; and
making the gaming information available for sale.

11. The computer readable storage medium of claim 10, wherein the gaming information is configured to be executed on a machine and serve as a tutorial to another user.

12. The computer readable storage medium of claim 10, wherein the gaming information comprises:
user inputs received by the gaming application during execution of the gaming application; and
outputs produced by the gaming application during execution of the gaming application, wherein the outputs include at least one of visual outputs, audio outputs, gameplay parameters and combinations thereof.

13. The computer readable storage medium of claim 10, wherein making the gaming information available for sale comprises:
hosting the gaming information on a web site or in a proprietary application; and
providing instructions to prospective buyers for contacting a seller of the gaming information.

14. The computer readable storage medium of claim 10, wherein the gaming information is recorded during gameplay by a process comprising:
recording user inputs received by the gaming application during execution of a segment of gameplay; and
recording outputs produced by the gaming application during execution of the segment of gameplay, wherein the outputs include at least one of visual outputs, audio outputs, gameplay parameters and combinations thereof.

15. A computer readable storage medium including instructions which, when executed by a processor, perform the method for recording gaming information comprising:
recording inputs of a user received by a gaming application during execution of a segment of gameplay; and
recording outputs produced by the gaming application during execution of the segment of gameplay, wherein the outputs include at least one of visual outputs, audio outputs, gameplay parameters and combinations thereof.

16. The computer readable storage medium of claim 15, wherein the gaming information is associated with one or more descriptive tags that describe characteristics of the gaming information, e.g., a game name or an identification of a segment of gameplay, wherein the one or more descriptive tags are produced by one of: user-entered inputs from the user and automatic generation by the gaming application.

17. The computer readable storage medium of claim 16, further comprising assigning a rating to the gaming information based on the content of the gaming information and the content of the one or more descriptive tags associated with the gaming information.

18. The computer readable storage medium of claim 15, wherein the recording of gaming information is initiated in response to a prompt to record the segment of gameplay, wherein:
the recorded segment of gameplay corresponds to a pending request for gaming information describing the segment of gameplay; and
the prompt is initiated by one of:
the gaming application; and
an application for recording gaming information.

19. A gaming system, comprising memory and at least one processor, and further comprising gaming information comprising:
inputs of a user received by a gaming application during execution of a segment of gameplay; and
outputs produced by the gaming application during execution of the segment of gameplay, wherein the outputs include at least one of visual outputs, audio outputs, gameplay parameters and combinations thereof, wherein the inputs and outputs were recorded during execution of the segment of gameplay in a manner allowing the gaming information to be transmitted electronically and allowing the segment of gameplay to be subsequently reproduced on a gaming system different from the gaming system on which the gaming information is recorded.

20. The gaming system of claim 19, wherein the gaming information is associated with one or more descriptive tags that describe characteristics of the gaming information, e.g., a game name or an identification of a segment of gameplay, wherein the one or more descriptive tags are produced by one of: user-entered inputs from the user and automatic generation by the gaming application.

21. The gaming system of claim 20, further comprising assigning a rating to the gaming information based on the content of the gaming information and the content of the one or more descriptive tags associated with the gaming information.

22. A system, comprising a processor and a memory and further comprising a web application configured to:
display representations of a plurality of gaming information files each containing gaming information recorded during a gaming session defined by execution of a segment of gameplay;
receive requests to purchase selected ones of the gaming information files, the requests including a form of electronic payment; and
transmit the selected ones of the gaming information files to respective purchasers.
